(19) United States
(12) Patent Application Publication
(10) Pub. No.: US 2018/0111359 A1
(43) Pub. Date: Apr. 26, 2018

(54) MULTI-PLY FILMS FOR STERILIZATION OR PASTEURIZATION PROCESSES

(71) Applicant: Printpack Illinois, Inc., Elgin, IL (US)

(72) Inventors: Ronald W. Komro, Smyrna, GA (US); James Donald Ray, II, Marietta, GA (US); Amy Whiteman Sherrill, Mableton, GA (US); Mickel Ernst Knight, Flower Mound, TX (US); Justin Edward Houck, Marietta, GA (US)

(21) Appl. No.: 15/562,546

(22) PCT Filed: Apr. 1, 2016
(86) PCT No.: PCT/US2016/025642

§ 371 Date: Sep. 28, 2017

Related U.S. Application Data
(60) Provisional application No. 62/141,783, filed on Apr. 1, 2015.

(51) Int. Cl. B32B 27/34; B32B 7/06; B32B 7/12; B32B 27/08; B32B 27/32; B32B 27/36; B65D 65/42; B65D 77/20

(52) U.S. Cl. CPC B32B 27/34; B65D 2577/2041; B32B 7/12; B32B 27/08; B32B 27/32; B32B 27/36; B65D 65/42; B65D 77/2024; B32B 2250/05; B32B 2250/24; B32B 2307/31; B32B 2307/518; B32B 2307/5825; B32B 2307/746; B32B 2439/46; B32B 2439/70; B32B 2439/80; B32B 2307/748; B32B 7/06

(57) ABSTRACT

Multi-ply films are provided that include a top layer affixed to a coextruded film. The coextruded film includes at least a first polyamide structural layer, a sealant layer, and a first tie layer that is disposed between the first polyamide structural layer and the sealant layer, in which the coextruded film is substantially free of an adhesive. Packages that include the multi-ply films and methods for sterilization are also provided.

### CROSS-REFERENCE TO RELATED APPLICATIONS

This application claims priority to U.S. Provisional Application No. 62/141,783, filed Apr. 1, 2015, which is incorporated herein by reference.

### FIELD OF THE INVENTION

The present application relates to multi-ply films, particularly multi-ply films that are suitable for use in sterilization or pasteurization processes.

### BACKGROUND

Various types of multi-ply films are used for packaging of products such as food, medicines, and the like. The features and functionality of the multi-ply films may be varied depending on the desired application. For example, in some instances it is desirable to have multi-ply films suitable for use in packaging that undergoes sterilization processes, such as retort sterilization, microwave assisted thermal sterilization (MATS), ultra-high temperature sterilization, or pasteurization processes, that often are performed at high temperatures, and in certain instances, for prolonged periods of time.

The multi-ply films used in such applications must have good burst strength to survive the internal pressures generated during the sterilization or pasteurization process. In addition, it often is desirable that the package be “easy open” so that the consumer can readily access the contents within the package. These features generally require that there be a compromise between maximizing burst strength and minimizing seal strength. These multi-ply films also generally must have sufficient tear resistance and gas barrier properties.

Although there are some multi-ply films capable of providing some of the needed features and functionality, existing multi-ply films still suffer from numerous deficiencies. For example, most multi-ply films suitable for sterilization or pasteurization are at least three-ply and require use of adhesives, both of which increase cost, waste, and/or manufacturing complexity and processing time. Thus, there remains a need to provide improved multi-ply films.

### SUMMARY

In one aspect, multi-ply films are provided. In one embodiment, the multi-ply film includes a top layer affixed to a coextruded film, in which the coextruded film includes a first polyamide structural layer, a sealant layer, and a first tie layer that is disposed between the first polyamide structural layer and the sealant layer, and the coextruded film is substantially free of an adhesive. In a further embodiment, the coextruded film also includes an outer layer, in which the first polyamide structural layer is disposed between the sealant layer and the outer layer, and a second tie layer that is disposed between the first polyamide structural layer and the outer layer. In yet a further embodiment, the coextruded film also includes a second polyamide structural layer, in which the second polyamide structural layer is disposed between the second tie layer and the outer layer, and a third tie layer that is disposed between the second polyamide structural layer and the outer layer.

In another aspect, packages are provided. In one embodiment, the package includes a multi-ply film as described above.

In yet another aspect, methods for sterilization are provided. In one embodiment, the method includes feeding a package as described above into a sterilizing chamber, in which the package has product disposed therein, and preserving the product within the sterilizing chamber by thermal sterilization.

In another aspect, rolls of film for forming a package are provided. In one embodiment, the roll of film includes a multi-ply film as described above.

Additional aspects will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale.

FIG. 1 is a cross-sectional view of one embodiment of a multi-ply film in accordance with the present disclosure.

FIG. 1A is a cross-sectional view of the coextruded film of the multi-ply film in FIG. 1 taken along line A-A.

FIG. 2 is a cross-sectional view of another embodiment of a coextruded film in a multi-ply film in accordance with the present disclosure.

FIG. 3 is a cross-sectional view of another embodiment of a coextruded film in a multi-ply film in accordance with the present disclosure.

FIG. 4 is a side elevation view of a package including a lidding formed from a multi-ply film in accordance with the present disclosure.

FIGS. 5 and 6 are graphs showing the burst strength and peel strength of multi-ply films in accordance with the present disclosure as compared to conventional multi-ply films.

### DETAILED DESCRIPTION

Improved multi-ply films have been developed that are suitable for use in sterilization processes, such as retort sterilization, microwave assisted thermal sterilization (MATS), or ultra-high temperature sterilization, or pasteurization processes. Generally described, the present multi-ply films include a top layer affixed to a coextruded film, in which the coextruded film is substantially free of an adhesive.

As used here, the term “multi-ply film” refers to two or more films affixed together using any suitable method, non-limiting examples of which include laminating, extruding, coating, and combinations thereof. Desirably, the multi-ply film is a “2-ply” or “two-ply” film (e.g., formed from two films, with or without one or more adhesive layers disposed between the two films) or a “3-ply” or “three-ply” film (e.g., formed from three films, with or without one or more adhesive layers disposed between any of the films), in which the coextruded film is substantially free of adhesive. Although the multi-ply films provided herein are primarily described with reference to two-ply films, three-ply films also are contemplated herein (e.g., including a foil layer or other film layer).

As used herein, “substantially free” means that the total amount of adhesive present within the coextruded film is less than about 1% by weight of the multi-ply film. For example, in certain embodiment, there is no adhesive between the first polyamide structural layer and the sealant layer, and in some embodiments also between the second polyamide structural layer and the outer layer. In another embodiment, the coextruded film does not comprise an adhesive.

As used herein, the term “adhesive” when used in the context of “substantially free” is defined as a composition that is coated onto the surface of a preformed material, such as a film or layer, such that the preformed material adheres or connects to another material that is subsequently disposed over the coated surface of the preformed material. For example, such adhesives may include adhesives that are used in adhesive lamination processes, such as aqueous, water or solvent, adhesives or cold seal adhesives. In contrast, coextruded films are typically produced by extruding two or more films or layers simultaneously that bond to each other when in the soft or molten state and then cooled. For purposes of this disclosure, preformed materials do not include extruded materials that are in the soft or molten state.

Several embodiments of multi-ply films, packages made at least in part therefrom, and methods for sterilization are described herein. Parameters of different steps, components, and features of the embodiments are described separately, but may be combined consistently with this description of claims, to enable other embodiments as well to be understood by those skilled in the art. Various terms used herein are likewise defined in the description which follows. Unless otherwise specified, quantities referred to by percentages (%) are by weight (wt %).

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In aspects, “about” can be used to mean within 10% of the recited value, within 5% of the recited value, or within 2% of the recited value.

The present multi-ply films include a top layer affixed to a coextruded film, in which the coextruded film is substantially free of an adhesive. It was discovered that by forming a film of the multi-ply film via co-extrusion, rather than using conventional adhesive, a greater adhesion among the layers of the film could be achieved, thereby reducing the amount of adhesive needed to bond the layers of the multi-ply film together. Decreasing the amount of adhesive advantageously results in reduced cost, waste, and/or manufacturing complexity and processing time of the multi-ply films compared to that of conventional multi-ply films. Moreover, given that every interface within a film is a potential failure point, by forming at least a portion of the multi-ply film via co-extrusion—i.e., the coextruded film—reduces the number of adhesive interfaces, which in turn beneficially reduces potential failure points of the overall multi-ply film.

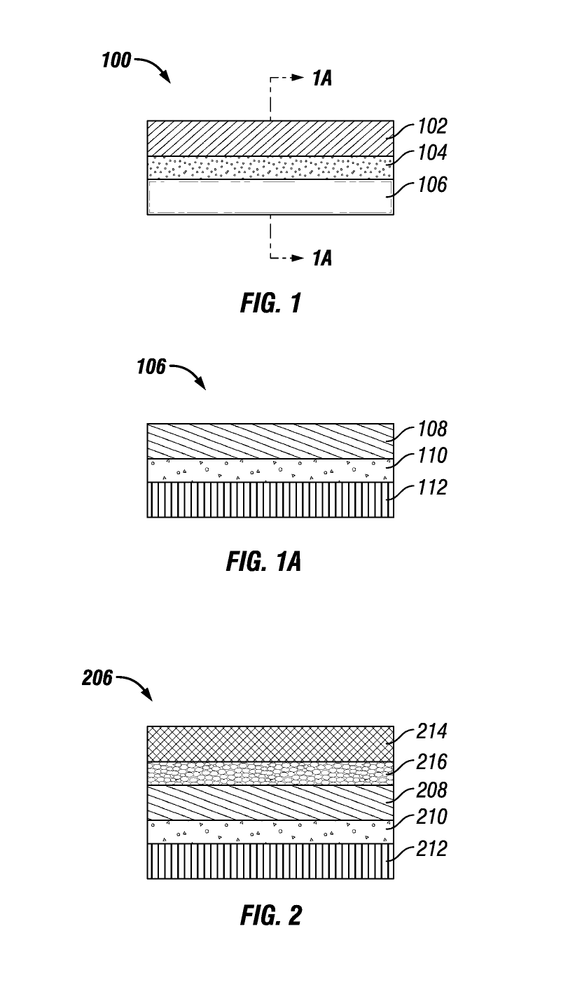

An exemplary multi-ply film 100 is illustrated in FIGS. 1 and 1A. The multi-ply film 100 includes a top layer 102 affixed to a coextruded film 106. In this particular embodiment, the coextruded film 106 is affixed to the top layer 102 via an adhesive layer 104, for example by way of adhesive lamination. In other embodiments, the adhesive layer 104 may be omitted. For example, the top layer 102 may be affixed to the coextruded film 106 via extrusion lamination, in which the extrudate, such as a polymeric extrudate (e.g., polypropylene and/or polyethylene), may be a single or a multi-layer extrudate. In instances where extrusion lamination is employed, a primer may be applied to the top layer, the coextruded film, or both, to aid in the bonding of the extrudate to the primed surface or surfaces.

As used herein, “polypropylene” can be a homo-polymer, a co-polymer of propylene and other one or more monomers, such as ethylene, or a combination thereof.

As used herein, “polyethylene” can be a homo-polymer, a co-polymer of ethylene and other one or more monomers, or a combination thereof.

In some embodiments, the top layer may include a polyolefin, an oriented polyester, an oriented polyamide, or combinations thereof. In a preferred embodiment, the top layer is an oriented polyester having a thickness from about 40 to about 120 gauge.

In certain embodiments, the material forming the top layer includes a high barrier coating and/or is metallized. In one embodiment, the top layer includes a high barrier coating and a polyolefin, an oriented polyester, an oriented polyamide, or combinations thereof. In another embodiment, the top layer is metallized and includes a polyolefin, an oriented polyester, an oriented polyamide, or combinations thereof. In yet another embodiment, the top layer is metallized and includes a high barrier coating and a polyolefin, an oriented polyester, an oriented polyamide, or combinations thereof.

The coextruded film 106 includes a first polyamide structural layer 108, a sealant layer 112, and a first tie layer 110. The first tie layer 110 is disposed between the first polyamide structural layer 108 and the sealant layer 112. The first tie layer 110 aids in the bonding of the first polyamide structural layer 108 to the sealant layer 112. In some embodiments, an inner layer is disposed between the first tie layer 110 and the sealant layer 112.

In certain embodiments, the first polyamide structural layer includes nylon. In one embodiment, the first polyamide structural layer includes biaxially unoriented nylon. It has been discovered that employing biaxially unoriented nylon, rather than biaxially oriented nylon used in conventional multi-ply films, beneficially provides for greater elongation of the multi-ply film, thereby increasing the burst strength of the multi-ply film, while yet still maintaining suitable peel strength. Additionally, biaxially unoriented nylon provides the ability to utilize the coextrusion process, thereby producing a coextruded film with minimal, if any, conventional adhesive. As stated above, in certain embodiments, the coextruded film does not comprise an adhesive.

Non-limiting examples of suitable sealant materials of the sealant layer include polypropylene, polyethylene, polyester, polycarbonate, and the like, and combinations thereof. In certain embodiments, the sealant layer includes a blend of an easy-peel component and a polypropylene. The easy-peel component may be present in the sealant layer in an amount from about 16 to about 28% by weight of the sealant layer, whereas the polypropylene may be present in the sealant layer in an amount from about 72 to about 84% by weight of the sealant layer. The sealant layer advantageously allows for the multi-ply film to be heat-sealed to a container (i.e., as a lidding) or to itself (i.e., to form a pouch) with sufficient strength to withstand sterilization or pasteurization but weak enough to be separated by a consumer after sterilization or pasteurization. For example, in certain embodiments the easy-peel component comprises a blend of a polypropylene, a polyethylene, an antiblock agent (e.g., diatomaceous earth), and a slip agent (e.g., erucamide).

Non-limiting examples of suitable first tie layer materials include-anhydride-modified polyolefins (e.g., anhydride modified polypropylene), modified ethylene vinyl acetate, anhydride modified ethylene acrylate, acid/acrylate modified ethylene vinyl acetate, anhydride modified ethylene vinyl acetate, anhydride modified ethylene vinyl acetate, and combinations thereof, and any of the foregoing materials in combination with polyolefins, such as polypropylene.

The type of materials in the first tie layer is based, at least in part on the materials of the opposing layers being bonded via the first tie layer. For example, where the first tie layer is used to bond a first polyamide structural layer comprising nylon and a sealant layer comprising a blend of an easy-peel component and a polypropylene, the first tie layer may comprise anhydride modified polypropylene or a combination of anhydride modified polypropylene and polypropylene.

In embodiments, the coextruded film may include one or more additional layers, and/or one or more of the foregoing layers may be formed from two or more adjacent layers, and/or one or more additional layers of the foregoing layers.

For example, in one embodiment, a coextruded film, illustrated in a cross-sectional view, of the present multi-ply films is shown in FIG. 2. In this particular embodiment, the coextruded film 206 includes 5 layers—a first polyamide structural layer 208, a first tie layer 210, a sealant layer 212, a second tie layer 216, and an outer layer 214. The first polyamide structural layer 208 is disposed between the sealant layer 212 and the outer layer 214, such that the outer layer 214 is affixed to the top layer (not shown) of the multi-ply film. The first tie layer 210 is disposed between the first polyamide structural layer 208 and the sealant layer 212, whereas the second tie layer 216 is disposed between the first polyamide structural layer 208 and the outer layer 214.

In embodiments, the outer layer of the coextruded film desirably comprises a polypropylene. The polypropylene may be blended with other polymers such as polyethylene to improve the bond between the outer layer of the coextruded film and the top layer. For example, the polypropylene may be present in the outer layer of the coextruded film in an amount from about 90 to about 100% by weight of the outer layer while the polyethylene may be present in the outer layer of the coextruded film in an amount from about 0 to about 10% by weight of the outer layer.

In certain embodiments, the coextruded film 206 may also include a second polyamide structural layer and a third tie layer, in which the second polyamide structural layer is disposed between the second tie layer 216 and the outer layer 214. In such embodiments, the third tie layer is disposed between the outer layer 214 and the second polyamide structural layer. In some embodiments, additional polyamide structural layers and additional tie layers may be included within the coextruded film, in which, for example, each polyamide structural layer is disposed between two separate tie layers.

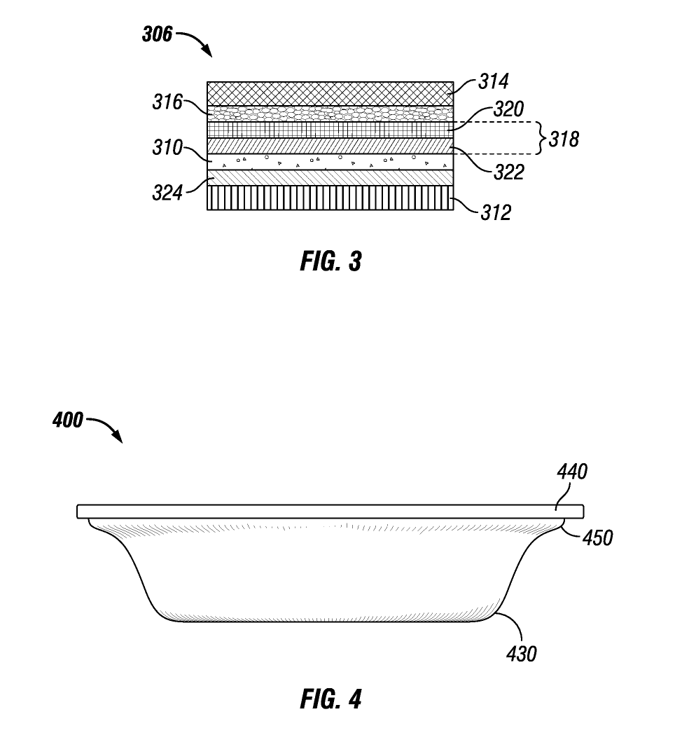

Another exemplary coextruded film, illustrated in a cross-sectional view, of the present multi-ply films is shown in FIG. 3. Similar to the five-layer coextruded film in FIG. 2, the first polyamide structural layer 308 is disposed between the sealant layer 312 and the outer layer 314, in which the second tie layer 316 is disposed between the first polyamide structural layer 308 and the outer layer 316; however, in this illustrated embodiment, the first polyamide structural layer 308 comprises adjacent polyamide layers 318, 320. In addition, the coextruded film 306 further includes at least one inner layer 324 between the first tie layer 310 and the sealant layer 312.

Non-limiting examples of suitable second tie layer materials include anhydride modified polypropylene, modified ethylene vinyl acetate, anhydride modified ethylene acrylate, acid/acrylate modified ethylene vinyl acetate, anhydride modified ethylene vinyl acetate, anhydride modified ethylene vinyl acetate, combinations thereof, and any of the foregoing materials in combination with polypropylene. The type of materials in the second tie layer is based, at least in part on the materials of the opposing layers being bonded via the second tie layer. For example, where the second tie layer is used to bond a first polyamide structural layer comprising nylon and an outer layer comprising polypropylene the second tie layer may comprise anhydride modified polypropylene or a combination of anhydride modified polypropylene and polypropylene.

In embodiments, the inner layer may include a polypropylene, polyethylene, or a combination thereof. The inner layer provides additional structure and function to the multi-ply film, such that the sealant layer may be formed at a desirable thickness. The thickness of the sealant layer affects the ability to effectively separate the multi-ply film from another substrate, e.g., in instances where the multi-ply film is an easy-to-peel lid. That is, if the sealant layer is too thick, the multi-ply film, when being separated from another substrate, such as a body substrate of container, may not result in a clean peel. As used herein, a “clean peel” is defined as a peel that results in a clean appearance, with minimal, if any, or no obvious stringing, fuzziness, tearing, or delamination.

The multi-ply film using the coextruded film generally is of the same thickness as conventional multi-layer films. For example, the total thickness of the multi-ply film may range from about 2.0 mils to about 10.0 mils, more particularly from about 3 mils to about 7 mils, or from about 3.5 mils to about 6 mils. The top layer may have a thickness from about 0.4 to about 1.2 mils and the coextruded film may have a thickness from about 1.5 to about 5.0 mils.

In instances where the coextruded film further includes an outer layer, the outer layer of the coextruded film may have a thickness from about 0.2 to about 1.2 mils, the first polyamide structural layer and the optional second structural layer may each have a thickness from about 0.4 to about 1.4 mils, and the sealant layer (together with the optional inner layer) may have a thickness from about 0.5 to about 2.5 mils.

The multi-ply films provided herein advantageously have an improved ratio of peel strength to burst strength as compared to three-ply films in which the top layer, biaxially-oriented nylon layer, and sealant layer are laminated together by two adhesive layers. For example, exemplary multi-ply films may have a peel strength from about 1000 grams to about 2500 grams and a burst strength of greater than about 7 PSI. The peel strength may be measured using the ASTM-F2824-10 Standard Test Method for Mechanical Seal Strength testing for Round Cups and Bowl Containers with Flexible Peelable Lids (i.e., using a pull rate of 0.5 inch/min for peak values and 12 inch/min for peel values). The burst strength may be measured using the ASTM-F1140-07 Standard Test Methods for Internal Pressurization Failure Resistance of Unrestrained Packages.

The multi-ply films provided herein may be formed by any of the conventional processes for making multi-ply films, including adhesive lamination, extrusion, coextrusion, blown extrusion, cast extrusion, extrusion coating, and combinations thereof. The top layer and coextruded film may be affixed together in-line or off-line with the forming of the coextruded film.

### Packages

The multi-ply films described herein may be used in a variety of packaging applications, such as in the formation of packages. In embodiments, the present multi-ply films may be formed in-line or off-line with the forming of a packaging. In certain embodiments, a roll of film comprising the multi-ply films described herein may be used to form a package.

In some embodiments, the multi-ply films described herein are used to form packages in which the multi-ply film is sealed to a container base, such as a rigid or semi-rigid tray or cup. FIG. 4 shows an exemplary package 400 comprising a rigid or semi-rigid container base 430 onto which a multi-ply film 440 as described herein may be attached. For example, the multi-ply film 440 may be heat sealed about a peripheral flange 450 (i.e., rim) of the container base 430. In certain embodiments, the package 400 may also include one or more fitments. The container base may be made of any suitable material, such as injection molded or thermoformed polypropylene, polyethylene, and the like; however, the composition of the container base 430 and sealant layer of the multi-ply film 440 should be compatible with one another so that the heat sealing creates a sealing interface between the container base and the multi-ply film. In some embodiments, it may be desirable that the multi-ply film include a pull tab that extends beyond the peripheral flange of the container base to allow a user to more readily grasp and peel the film to open the package.

In another embodiment, the multi-ply films described herein may be sealed to itself or to another film to form a pouch by forming heat seals about the periphery of the pouch body. The other film may be the same or different than the multi-ply film. In certain embodiments, the packages further include one or more fitments.

### Methods for Sterilization

The multi-ply films described herein are suitable for use in sterilization processes, particularly thermal sterilization of products, such as food, medicine, and the like. Non-limiting examples of thermal sterilization include retort sterilization, microwave assisted thermal sterilization (MATS), such as those described in U.S. Pat. Nos. 5,436,432, 5,750,966, 6,618,957, 7,230,217, 7,607,860, 8,878,109, 9,066,376, 9,179,505, and 9,271,338, all of which are incorporated herein by reference, ultra-high temperature sterilization, and the like, and combinations thereof.

In embodiments, the method for sterilization includes feeding a package as described herein into a sterilizing chamber, in which the package has product disposed therein; and preserving the product within the sterilizing chamber by thermal sterilization. In one embodiment, the coextruded film of the multi-ply film is substantially free of an adhesive and includes a first polyamide structural layer, a sealant layer, and a first tie layer that is disposed between the first polyamide structural layer and the sealant layer. In another embodiment, the coextruded film further includes an outer layer, in which the first polyamide structural layer is disposed between the sealant layer and the outer layer, and a second tie layer is disposed between the first polyamide structural layer and the outer layer. In yet another embodiment, the coextruded film further comprises a second polyamide structural layer, in which the second polyamide structural layer is disposed between the second tie layer and the outer layer, and a third tie layer is disposed between the second polyamide structural layer and the outer layer.

In some embodiments, the thermal sterilization includes exposing the package to a heat medium to heat the product within the package to a predetermined temperature and to maintain the product at the predetermined heating temperature for a predetermined time.

In other embodiments, the thermal sterilization includes exposing the package to a heat medium to heat the product within the package to a predetermined temperature and to maintain the product at the predetermined heating temperature for a predetermined time and also exposing the heat medium, the package, and the product to microwave energy.

In embodiments, the heat medium may be pressurized high temperature water or steam.

Embodiments of the present description are further illustrated by the following examples, which are not to be construed in any way as imparting limitations upon the scope thereof. On the contrary, it is to be clearly understood that sterilization and/or pasteurization processes may be conducted on various other embodiments, modifications, and equivalents thereof which, after reading the description therein, may suggest themselves to those skilled in the art without departing from the spirit of the present invention and/or the scope of the appended claims.

### Examples

A two-ply film was prepared including a seven-layer coextruded film and was compared to a conventional three-ply laminate (control), the structures of which are summarized below.

| Control | Exemplary |
|---|---|
| Three-Ply Film | Two-Ply Film |
| 48 gauge transparent barrier coated | 48 gauge transparent barrier coated |
| polyester | polyester |
| Retort Adhesive | Retort Adhesive |
| 60 gauge biaxially oriented nylon | 3.25 mil Coextruded Sealant Film: |
| Retort Adhesive | white polypropylene copolymer/ |
| 2.75 mil easy peel polypropylene | anhydride-grafted polypropylene/ |
| | nylon/ |
| | nylon/ |
| | anhydride-grafted polypropylene/ |
| | white polypropylene copolymer/ |
| | retort easy peel blend |

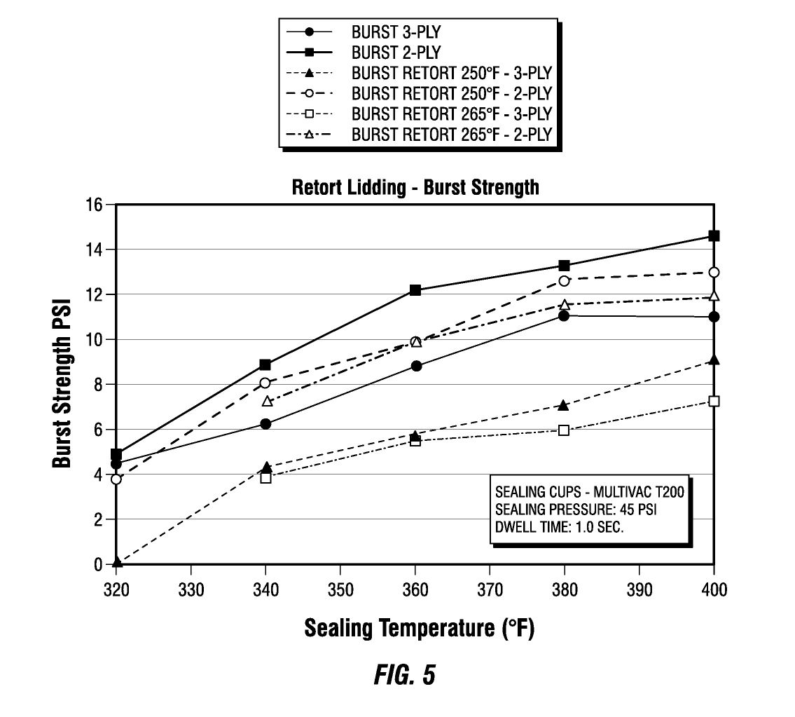

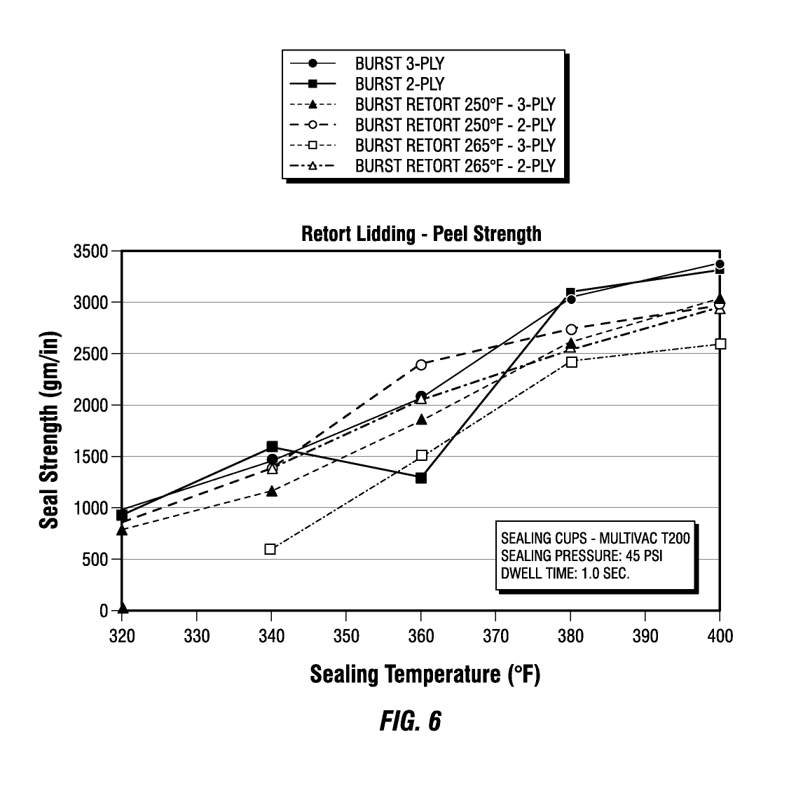

The burst strength and peel strength of the finished films were tested both in the form of a flat lidding-stock and after being heat-sealed to a container base (both pre- and post-retort) using the methods described above. The retort samples were test retorted at both 250° F./30 psi/60 min and at 265° F./35 psi/30 minutes. The results are shown in FIGS. 5-6.

Although the films had similar peel strengths, the two-ply film had a distinctive improvement in post-retort burst strengths. In addition, the two-ply films had less “fuzz” stringing and tearing as compared to the three-ply laminate.

The following numbered aspects, embodiments, and features of the disclosure are provided, with an emphasis on the ability to combine the various features which may disclosed only in certain embodiments, into other disclosed embodiments, as the context and technical reason allow.
Clause 1. A multi-ply film comprising a top layer affixed to a coextruded film, wherein:
the coextruded film comprises a first polyamide structural layer, a sealant layer, and a first tie layer disposed between the first polyamide structural layer and the sealant layer; and
the coextruded film is substantially free of an adhesive.
Clause 2. The multi-ply film of clause 1, wherein the coextruded film further comprises an outer layer, in which the first polyamide structural layer is disposed between the sealant layer and the outer layer, and a second tie layer disposed between the first polyamide structural layer and the outer layer.
Clause 3. The multi-ply film of clause 2, wherein the coextruded film further comprises a second polyamide structural layer, in which the second polyamide structural layer is disposed between the second tie layer and the outer layer, and a third tie layer disposed between the second polyamide structural layer and the outer layer.
Clause 4. The multi-ply film of any one of clauses 1 to 3, wherein the first polyamide structural layer comprises adjacent layers of polyamide.
Clause 5. The multi-ply film of any one of clauses 1 to 3, wherein the first polyamide structural layer, the second polyamide structural layer, or a combination of the first and second polyamide structural layers comprises a nylon.
Clause 6. The multi-ply film of any one of clauses 1 to 3, wherein the coextruded film further comprises an inner layer disposed between the sealant layer and the first tie layer.
Clause 7. The multi-ply film of clause 6, wherein the inner layer comprises a polypropylene, a polyethylene, or a combination thereof.
Clause 8. The multi-ply film of any one of clauses 1 to 3, wherein the sealant layer comprises a blend of an easy-peel component and a polypropylene.
Clause 9. The multi-ply film of clause 8, wherein the easy-peel component is present in the sealant layer of the coextruded film in an amount from about 16 to about 28% by weight of the sealant layer and the polypropylene is present in the sealant layer of the coextruded film in an amount from about 72 to about 84% by weight of the sealant layer.
Clause 10. The multi-ply film of clause 8, wherein the easy-peel component comprises a heat-sealable blend of a polypropylene, a polyethylene, an antiblock agent, and a slip agent.
Clause 11. The multi-ply film of clause 10, wherein the antiblock agent comprises diatomaceous earth.
Clause 12. The multi-ply film of clause 10, wherein the slip agent comprises erucamide.
Clause 13. The multi-ply film of clause 2 or 3, wherein the outer layer of the coextruded film comprises a polypropylene.
Clause 14. The multi-ply film of any one of clauses 1 to 3, wherein the top layer comprises an oriented polyester, an oriented polyamide, or a combination thereof.
Clause 15. The multi-ply film of clause 14, wherein the top layer further comprises a high barrier coating.
Clause 16. The multi-ply film of clause 2 or 3, wherein the outer layer of the coextruded film comprises a blend of a polypropylene and a polyethylene.
Clause 17. The multi-ply film of clause 16, wherein the polypropylene is present in the outer layer of the coextruded film in an amount from about 90 to about 100% by weight of the outer layer.
Clause 18. The multi-ply film of any one of clauses 1 to 3, wherein the multi-ply film comprises a two-ply film.
Clause 19. The multi-ply film of clause 18, wherein the multi-ply film has an improved ratio of peel strength:burst strength as compared to a three-ply film comprising the top layer, a biaxially-oriented nylon layer, and a sealant layer affixed together by adhesive layers.
Clause 20. The multi-ply film of clause 19, wherein the peel strength is from about 1000 grams to about 2500 grams and the burst strength is greater than about 7 PSI.
Clause 21. The multi-ply film of any one of clauses 1 to 3, wherein the multi-ply film comprises a three-ply film.
Clause 22. The multi-ply film of clause 21, wherein the multi-ply film further comprises a foil layer.
Clause 23. A package comprising a multi-ply film that comprises a top layer affixed to a coextruded film, wherein:
the coextruded film comprises a first polyamide structural layer, a sealant layer, and a first tie layer disposed between the first polyamide structural layer and the sealant layer; and
the coextruded film is substantially free of an adhesive.
Clause 24. The package of clause 23, wherein the coextruded film further comprises an outer layer, in which the first polyamide structural layer is disposed between the sealant layer and the outer layer, and a second tie layer disposed between the first polyamide structural layer and the outer layer.
Clause 25. The package of clause 24, wherein the coextruded film further comprises a second polyamide structural layer, in which the second polyamide structural layer is disposed between the second tie layer and the outer layer, and a third tie layer disposed between the second polyamide structural layer and the outer layer.
Clause 26. The package of clause 23, wherein the package comprises a pouch formed from the multi-ply film.
Clause 27. The package of clause 26, wherein the package further comprises one or more fitments.
Clause 28. The package of clause 23, wherein the package comprises a rigid or semi-rigid container having a rim for affixing the multi-ply film thereto.
Clause 29. The package of clause 28, wherein the top layer of the multi-ply film comprises at least one pull tab.
Clause 30. A method for sterilization, the method comprising:
feeding the package of any one of clauses 23 to 29 into a sterilizing chamber, wherein the package has product disposed therein; and
preserving the product within the sterilizing chamber by thermal sterilization.
Clause 31. The method of clause 30, wherein the thermal sterilization is retort sterilization.
Clause 32. The method of clause 30, wherein the thermal sterilization is microwave assisted thermal sterilization, or ultra-high temperature sterilization.
Clause 33. The method of clause 30, wherein the thermal sterilization comprises exposing the package to a heat medium to heat the product within the package to a predetermined temperature and to maintain the product at the predetermined heating temperature for a predetermined time.
Clause 34. The method of clause 33, wherein the heat medium is pressurized high temperature water or steam.
Clause 35. The method of clause 33, wherein the thermal sterilization further comprises exposing the heat medium, the package, and the product to microwave energy.
Clause 36. A roll of film for forming a package, said roll of film comprising the multi-ply film in any one of clauses 1 to 3.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1. A multi-ply film comprising a top layer that is affixed to a coextruded film by an adhesive layer disposed between the top layer and the coextruded film, wherein:
the coextruded film comprises a first polyamide structural layer, a sealant layer, and a first tie layer disposed between the first polyamide structural layer and the sealant layer; and
the coextruded film is substantially free of an adhesive,
wherein the first polyamide structural layer is a biaxially unoriented nylon.

2. The multi-ply film of claim 1, wherein the coextruded film further comprises an outer layer, in which the first polyamide structural layer is disposed between the sealant layer and the outer layer, and a second tie layer disposed between the first polyamide structural layer and the outer layer.

3. The multi-ply film of claim 2, wherein the coextruded film further comprises a second polyamide structural layer, in which the second polyamide structural layer is disposed between the second tie layer and the outer layer, and a third tie layer disposed between the second polyamide structural layer and the outer layer.

4. The multi-ply film of claim 1, wherein the first polyamide structural layer comprises adjacent layers of biaxially unoriented nylon or the second polyamide structural layer comprises a nylon.

5. (canceled)

6. The multi-ply film of claim 1, wherein the coextruded film further comprises an inner layer comprising a polypropylene, a polyethylene, or combination thereof disposed between the sealant layer and the first tie layer.

7. (canceled)

8. The multi-ply film of claim 1, wherein the sealant layer comprises a blend of an easy-peel component and a polypropylene.

9. The multi-ply film of claim 8, wherein the easy-peel component is present in the sealant layer of the coextruded film in an amount from about 16 to about 28% by weight of the sealant layer and the polypropylene is present in the sealant layer of the coextruded film in an amount from about 72 to about 84% by weight of the sealant layer and the easy-peel component comprises a heat-sealable blend of a polypropylene, a polyethylene, an antiblock agent, and a slip agent.

10. (canceled)

11. The multi-ply film of claim 9, wherein the antiblock agent comprises diatomaceous earth.

12. The multi-ply film of claim 9, wherein the slip agent comprises erucamide.

13. The multi-ply film of claim 2, wherein the outer layer of the coextruded film comprises a polypropylene or a blend of apolypropylene and a polyethylene.

14. The multi-ply film of claim 1, wherein the top layer comprises an oriented polyester, an oriented polyamide, or a combination thereof.

15. The multi-ply film of claim 14, wherein the top layer further comprises a high barrier coating.

16. (canceled)

17. The multi-ply film of claim 13, wherein the polypropylene is present in the outer layer of the coextruded film in an amount from about 90 to about 100% by weight of the outer layer.

18. (canceled)

19. The multi-ply film of claim 1, wherein the multi-ply film comprises a two-ply film and wherein the multi-ply film has an improved ratio of peel strength:burst strength as compared to a three-ply film comprising the top layer, a biaxially-oriented nylon layer, and a sealant layer affixed together by adhesive layers.

20. (canceled)

21. The multi-ply film of claim 1, wherein the multi-ply film comprises a three-ply film and further comprises a foil layer.

22. (canceled)

23. A package comprising the multi-ply film of claim 1.

24.-25. (canceled)

26. The package of claim 23, wherein the package comprises a pouch formed from the multi-ply film.

27. (canceled)

28. The package of claim 23, wherein the package comprises a rigid or semi-rigid container having a rim for affixing the multi-ply film thereto.

29. (canceled)

30. The package of claim 23, wherein the first polyamide structural layer comprises adjacent layers of biaxially unoriented nylon.

31. The package of claim 30, wherein the coextruded film further comprises an inner layer disposed between the sealant layer and the first tie layer.

32. A method for sterilization, the method comprising:
feeding the package of claim 23 into a sterilizing chamber, wherein the package has product disposed therein; and
preserving the product within the sterilizing chamber by thermal sterilization.

33. The method of claim 32, wherein the thermal sterilization is retort sterilization, microwave assisted thermal sterilization, or ultra-high temperature sterilization.

34.-37. (canceled)

38. A roll of film for forming a package, said roll of film comprising the multi-ply film in claim 1.

39.-42. (canceled)

43. The multi-ply film of claim 2, wherein the first tie layer, the second tie layer, or both comprise anhydride modified polypropylene, modified ethylene vinyl acetate, anhydride modified ethylene acrylate, acid/acrylate modified ethylene vinyl acetate, anhydride modified ethylene vinyl acetate, and combinations thereof.

44. (canceled)

45. A method of making a multi-ply film comprising
affixing a top layer to a coextruded film by an adhesive layer disposed between the top layer and the coextruded film, wherein:
the coextruded film comprises a first polyamide structural layer, a sealant layer, and a first tie layer disposed between the first polyamide structural layer and the sealant layer; and
the coextruded film is substantially free of an adhesive,
wherein the first polyamide structural layer is a biaxially unoriented nylon.

46.-66. (canceled)
